(19) United States
(12) Patent Application Publication
(10) Pub. No.: US 2014/0095097 A1
(43) Pub. Date: Apr. 3, 2014

(54) SYSTEM AND METHOD FOR DETERMINING LINE EDGE ROUGHNESS

(71) Applicant: INTERNATIONAL BUSINESS MACHINES CORPORATION, Armonk, NY (US)

(72) Inventor: Daniel F. Moore, Hopewell Junction, NY (US)

(73) Assignee: INTERNATIONAL BUSINESS MACHINES CORPORATION, Armonk, NY (US)

(21) Appl. No.: 13/630,339

(22) Filed: Sep. 28, 2012

(51) Int. Cl. G01B 21/02; G01N 37/00; G06F 15/00

(52) U.S. Cl. 702/82; 702/158

(57) ABSTRACT

A method and system for determining line edge roughness is disclosed. The method involves computing a first length for a plurality of points based on a first line size, computing a second length for the plurality of points based on a second line size, and determining a fractal dimension line edge roughness parameter based on a difference between the first length and the second length.

### FIELD OF THE INVENTION

The present invention relates generally to semiconductors, and more particularly, to a system and method for measuring line edge roughness.

### BACKGROUND OF THE INVENTION

Efforts of the semiconductor fabricating industry to produce continuing improvements in miniaturization and packing densities has seen improvements and new challenges to the semiconductor fabricating process. With pitch sizes dropping below 100 nm, the phenomenon of line-edge roughness is now a serious problem. Defects in photoresist may produce ripples and uneven line edges in trenches and other structures formed during the semiconductor fabrication process.

As the size of features within chips decreases, the need to characterize the roughness of the feature more precisely and specifically is becoming more and more critical. The standard method to characterizing this roughness from CDSEM (Critical Dimension Scanning Electron Microscope) or CDAFM (Critical Dimension Atomic Force Microscope) measurements is using the standard deviation or some related statistical technique of the line or trench width. However, this traditional method is lacking when the roughness is anything other than normally distributed. In some cases, even low levels of line-edge roughness are producing unacceptable results. Therefore, it is desirable to have improved methods of measuring and quantifying line edge roughness.

### SUMMARY OF THE INVENTION

In one embodiment, a method of determining line edge roughness is provided. The method involves computing a first length for a plurality of points based on a first line size, computing a second length for the plurality of points based on a second line size, and determining a fractal dimension line edge roughness parameter based on a difference between the first length and the second length.

In another embodiment, a system is provided. The system has a processor. The processor is configured and disposed to access non-transitory memory. The non-transitory memory contains instructions, that when executed by the processor, perform the steps of, computing a first length for a plurality of points based on a first line size, computing a second length for the plurality of points based on a second line size, and determining a fractal dimension line edge roughness parameter based on a difference between the first length and the second length.

In another embodiment, a computer program product embodied in a non-transitory computer readable medium for execution by a processor is provided. The computer program product comprises code for computing a first length for a plurality of points based on a first line size, code for computing a second length for the plurality of points based on a second line size, and code for determining a line edge roughness parameter based on a difference between the first length and the second length.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. In some cases, in particular pertaining to signals, a signal name may be oriented very close to a signal line without a lead line to refer to a particular signal, for illustrative clarity.

Similar elements may be referred to by similar numbers in various figures (FIGs) of the drawing, in which case typically the last two significant digits may be the same, the most significant digit being the number of the drawing figure (FIG). Furthermore, for clarity, some reference numbers may be omitted in certain drawings.

FIG. 1 shows examples of line edge roughness.

FIG. 2 illustrates multiple segments.

FIG. 3A and FIG. 3B show multi-segment line measuring.

FIG. 4A and FIG. 4B show examples of graphically determining a fractal dimension line edge roughness parameter.

FIG. 5 is a flowchart indicating process steps for an embodiment of the present invention.

FIG. 6 is a system diagram in accordance with an embodiment of the present invention.

FIG. 7A and FIG. 7B show exemplary programming instructions for an embodiment of the present invention.

### DETAILED DESCRIPTION OF THE INVENTION

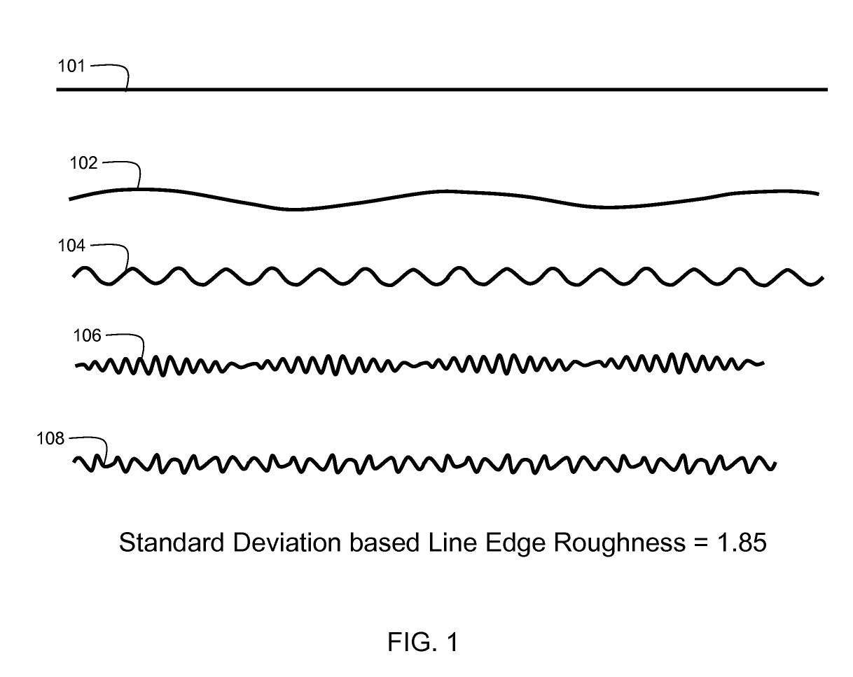

FIG. 1 shows examples of line edge roughness. Four lines having a line edge roughness are shown (102, 104, 106, and 108). Each line is theoretically intended to be the ideal case of line 101. Lines 102, 104, 106 and 108 each exhibit a measure of line edge roughness (LER). Using prior art methods of standard deviation (SD) based line edge roughness, each of the four lines (102, 104, 106, and 108) has a SD LER value of about 1.85, even though the four lines (102, 104, 106, and 108) have considerably different roughness profiles. For example, line 102 changes gradually, while line 106 has bursts of higher frequency change. It is desirable to have a measurement for line edge roughness that distinguishes between the various roughness profiles indicated in the four lines (102, 104, 106, and 108).

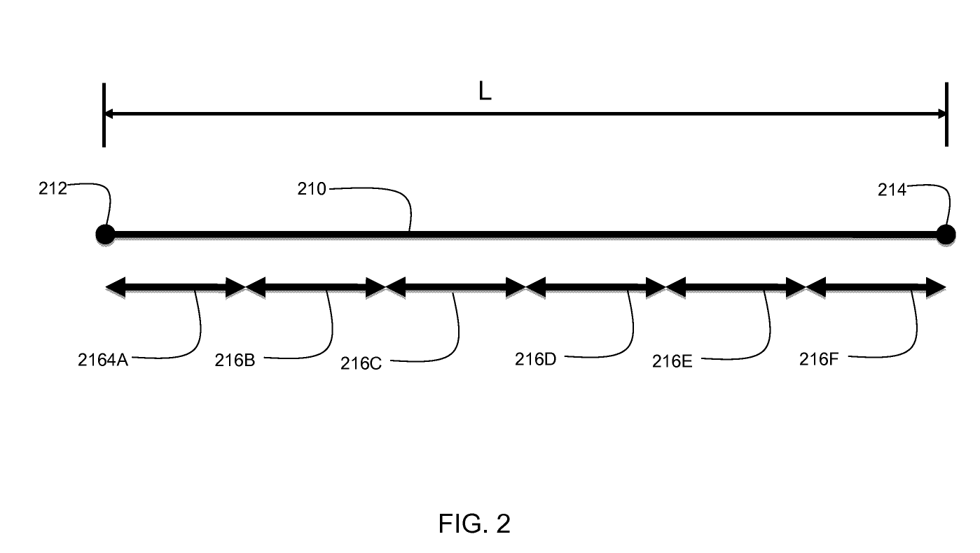

FIG. 2 illustrates the concept of multiple segments in accordance with embodiments of the present invention. Curve 210 has a first measuring point 212 and a second measuring point 214. In the ideal case (no line edge roughness is present) the curve 210 is a straight line of length L. Multiple segments are used to measure the curve 210. In FIG. 2, six segments are shown (216A-216F). In embodiments of the present invention, multiple segments are used to measure the line. Multiple measurements of the same two measuring points are made with the number of segments N being varied. For each value of N, a different length value is measured (on a non-ideal curve).

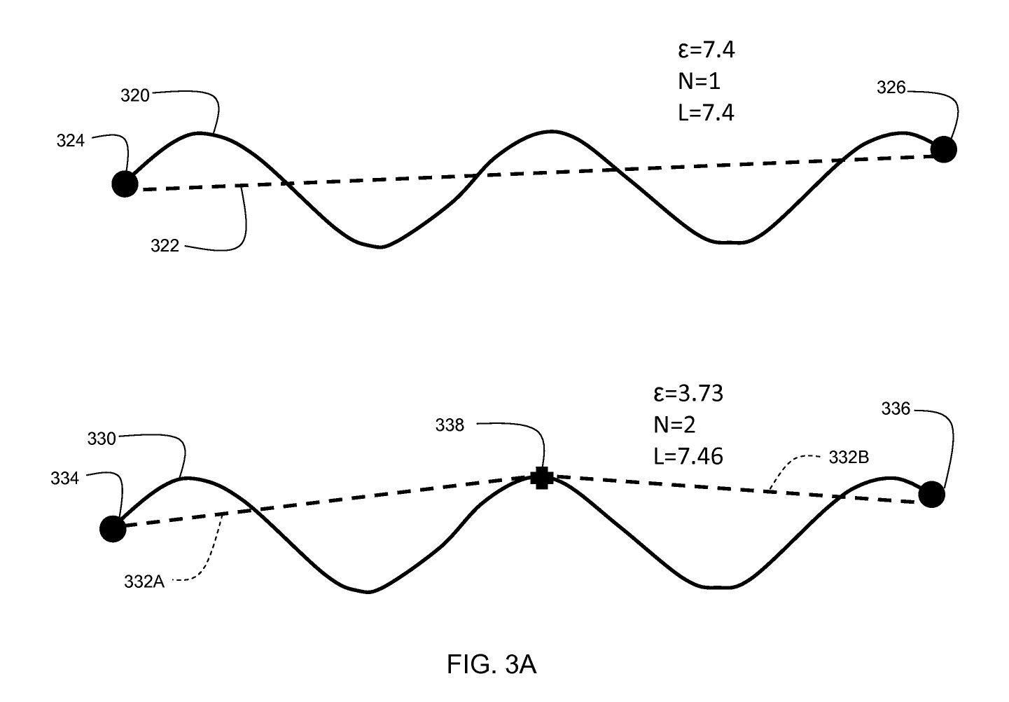

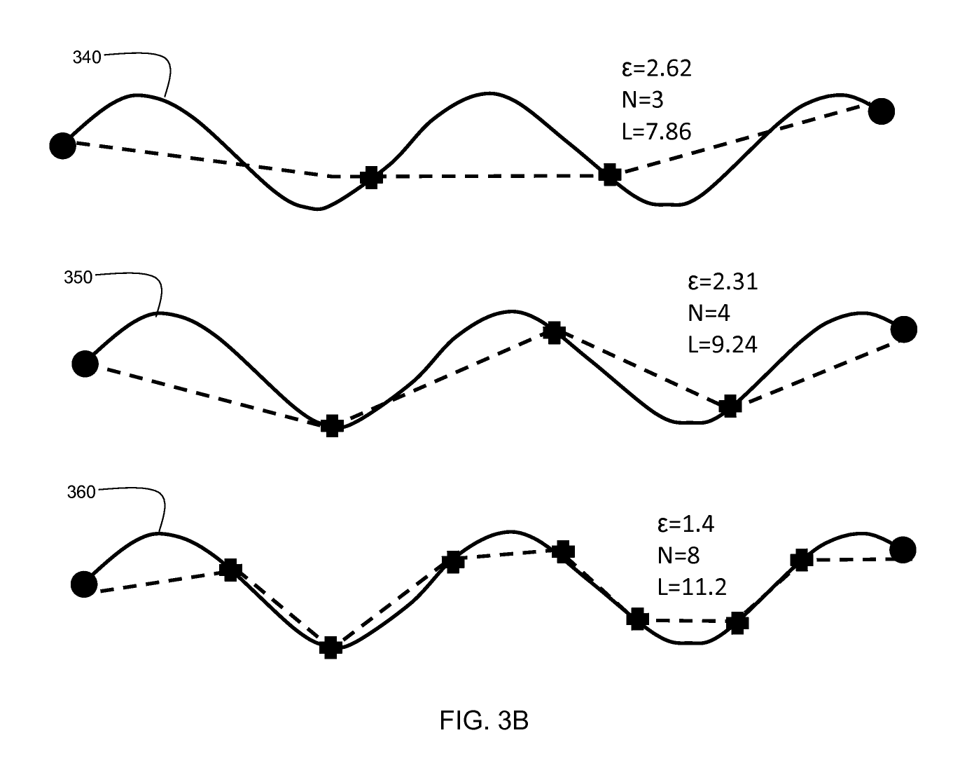

FIG. 3A and FIG. 3B show multi-segment line measuring. FIG. 3A shows curve 320. Curve 320 is non-ideal (not a straight line) and has a line edge roughness associated with it. In this case, one line segment 322 is used for measuring (N=1). The distance (in arbitrary units) between first measuring point 324 and second measurement point 326 is 7.4. The measuring points 324 and 326 are indicated by a circle symbol. An epsilon value is defined as: E=L/N

Where N is the number of line segments, and L is the sum of the length of the N line segments. When N=1, the epsilon value for curve 320 is: E=7.4/1=7.4.

Referring now to curve 330, which is the same as curve 320, a second measurement is now performed, increasing the number of segments to two (N=2). The first line segment 332A measures from first measuring point 334 to an intermediate point 338 (intermediate points are indicated by a cross symbol). The second line segment 332B measures from intermediate point 338 to second measuring point 336. The length L computed in this case is 7.46 (L is the length of segment 332A plus the length of segment 332B). Computing the epsilon value for this data set results in: E=L/N=7.46/2=3.73

The length and corresponding epsilon data for each value of N is used to determine a fractal dimension line edge roughness parameter, which is based on the difference between the first length (7.4) and the second length (7.46).

FIG. 3B shows three additional curves (340, 350, and 360). Curves 340, 350, and 360 are identical to curve 320 of FIG. 3A. For each curve of FIG. 3B, the segment number N value is varied. The segment number N is based on the number of lines used for a measurement. For curve 340, N=3, L=7.86, and E=2.62. For curve 350, N=4, L=9.24, and E=2.31. For curve 360, N=8, L=11.2, and E=1.4. For the purpose of clarity, not all measuring points and intermediate points are indicated with reference numbers. As stated previously, intermediate points are indicated with a cross symbol and measuring points are indicated with a circle symbol. As can be seen in FIGS. 3A and 3B, as N increases, L increases, and E decreases. This information is then used to derive a fractal dimension line edge roughness (FDLER) parameter.

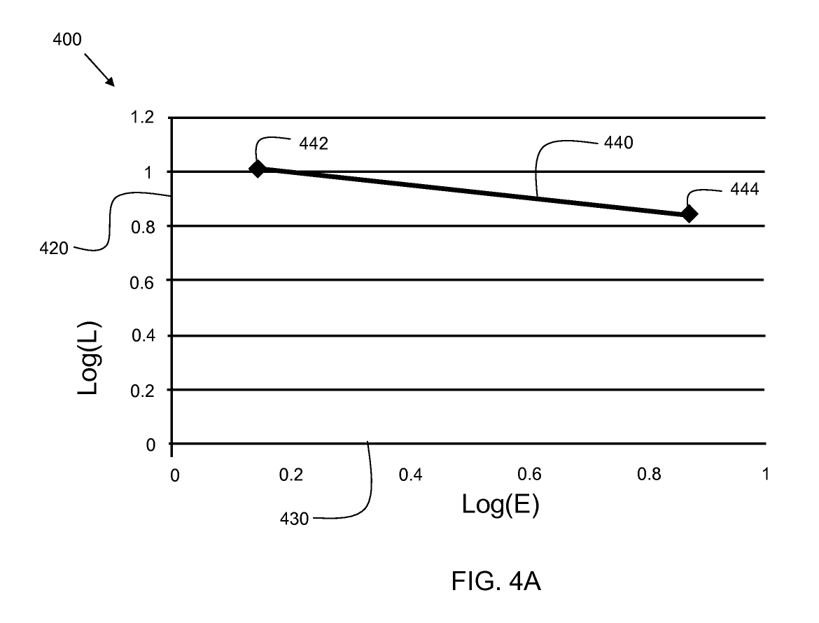

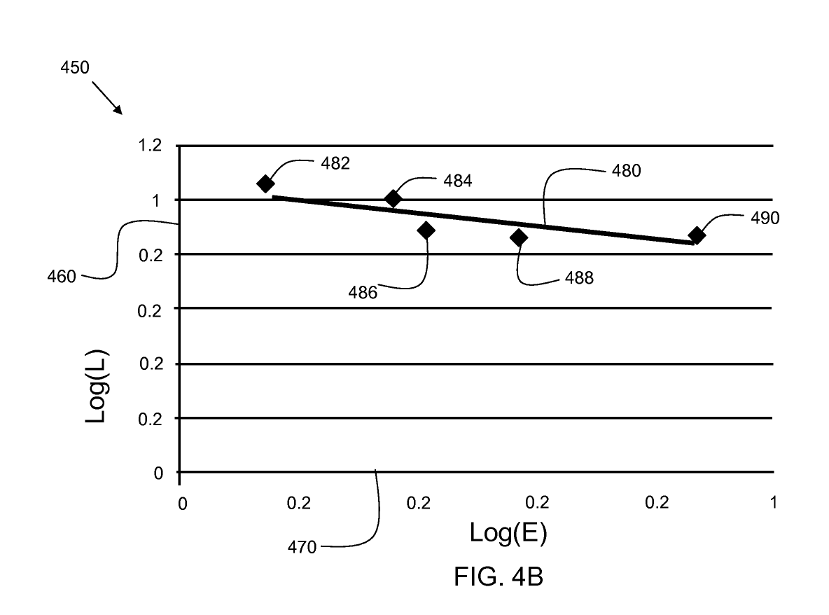

FIG. 4A and FIG. 4B show examples of graphically determining a fractal dimension line edge roughness parameter. FIG. 4A shows graph 400, which shows dimensional points 442 and 444. The horizontal axis 430 of graph 400 is the log of the epsilon value (Log(E)). The vertical axis 420 of graph 400 is the log of the length L of the sum of the segments. Two dimensional points are shown in graph 400.

For dimensional point 442, the XY coordinate values are derived from the data from curve 360 as follows:

X=Log(E)=log(1.4)=0.146

Y=Log(L)=log(11.2)=1.04

For dimensional point 444, the XY coordinate values are derived from curve 320 as follows:

X=Log(E)=log(7.4)=0.869

Y=Log(L)=log(7.4)=0.869

The dimensional points are plotted on graph 400, and line 440 intersects both dimensional points. The slope S of line 440 is computed. The FDLER parameter is 1−S. In this case, the slope S of line 440 is:

deltaY/deltaX=(0.869−1.04)/(0.869−0.146)=−0.171/0.723=−0.24

Therefore: FDLER=1−S=1−−0.24=1.24.

FIG. 4B shows an additional embodiment, where multiple dimensional points are plotted, with each dimensional point being based on a different pair of (Epsilon, L) data sets. In this example, there are 5 dimensional points (482, 484, 486, 488, and 490) plotted on graph 450, using X=log(E) and Y=log(L) for multiple values of N. The horizontal axis 470 of graph 450 is the log of the epsilon value (Log(E)). The vertical axis 460 of graph 450 is the log of the length L of the sum of the segments. Line 480 is best fit amongst the 5 dimensional points (482, 484, 486, 488, and 490), and the slope S of the best fit line 480 is then used to derive the FDLER parameter by FDLER=1−S, similar to the case described for FIG. 4A. In this embodiment, multiple N values can be used to derive the FDLER parameter. Note that while a total of five dimensional points are illustrated in FIG. 4B, some embodiments may have many more dimensional points. Some embodiments may have between 100 and 1000 dimensional points.

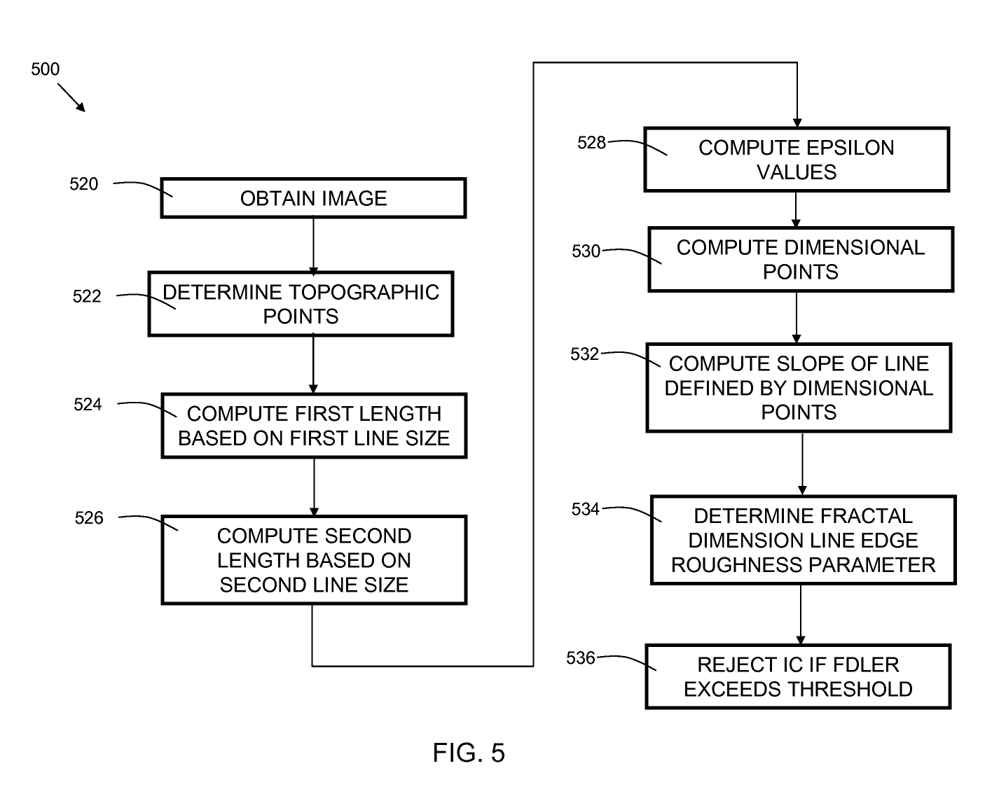

FIG. 5 is a flowchart 500 indicating process steps for an embodiment of the present invention. In process step 520, an image is obtained from an imaging system. The imaging system may comprise a scanning electron microscope (SEM) or other suitable imaging device. In process step 522, topographic points are determined. This may comprise performing image analysis such as edge detection to identify a line edge, and then identifying a plurality of XY coordinates that define the line. In process step 524, a first length is computed based on a first line size. The first length may be computed between two adjacent measurement points (see 324 and 326 of FIG. 3A). The first length may be computed using a first line size (see 322 of FIG. 3A). In process step 526, a second length is computed based on a second line size (see 330 of FIG. 3A). The second line size may be smaller than the first line size (e.g. line 332A is smaller than line 322 in FIG. 3A). The number of segments N is higher with the second measurement than the first measurement. In process step 528, epsilon values are computed for each data set of length L and number of segments N. In process step 530, dimensional points are computed (see 442 and 444 of FIG. 4A). In process step 532, the slope of a line defined by the dimensional points is computed. In process step 534, a fractal dimension line edge roughness (FDLER) parameter is computed, based on the slope. In process step 536, an integrated circuit (IC) is rejected if the FDLER parameter value exceeds a predetermined threshold. In some embodiments, the predetermined threshold value ranges from 1.4 to 1.6. In this way, circuits that have unacceptable levels of line edge roughness can be screened out during production.

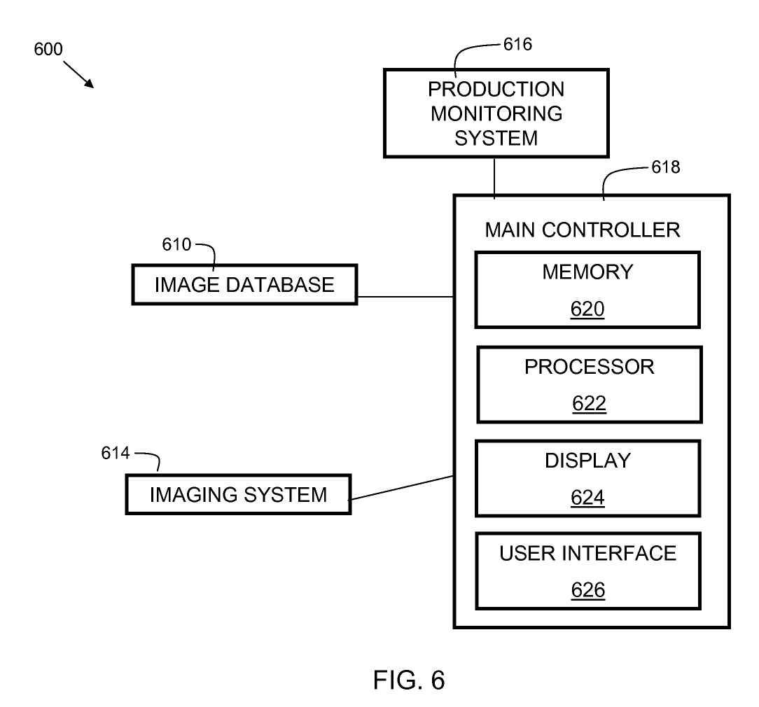

FIG. 6 is a diagram of a system 600 in accordance with an embodiment of the present invention. System 600 comprises a main controller 618. Main controller 618 may be a computer comprising memory 620, and a processor 622 which is configured to read and write memory 620. The memory 620 may be non-transitory memory, such as flash, ROM, non-volatile static ram, or the like. The memory 620 contains instructions that, when executed by processor 622, control the various subsystems to operate system 600. Main controller 618 may also comprise a display 624 and a user interface 626 for interacting with the system 600. The user interface 626 may comprise a keyboard, touch screen, mouse, or the like.

The main controller 618 may receive imaging data from imaging system 614. Imaging system 614 may comprise a scanning electron microscope. Main controller 618 may also receive data from an image database 610. The image database 610 may contain data for multiple images from multiple imaging systems. In this way, a single system may analyze line edge roughness from multiple fabrication systems. Main controller 618 may communicate with production monitoring system 616. Production monitoring system 616 may track yield, and other statistics regarding line edge roughness. For example, it may keep track of, and visually display (e.g. via a plot) the trend of the FDLER parameter, to identify process variables that may affect FDLER.

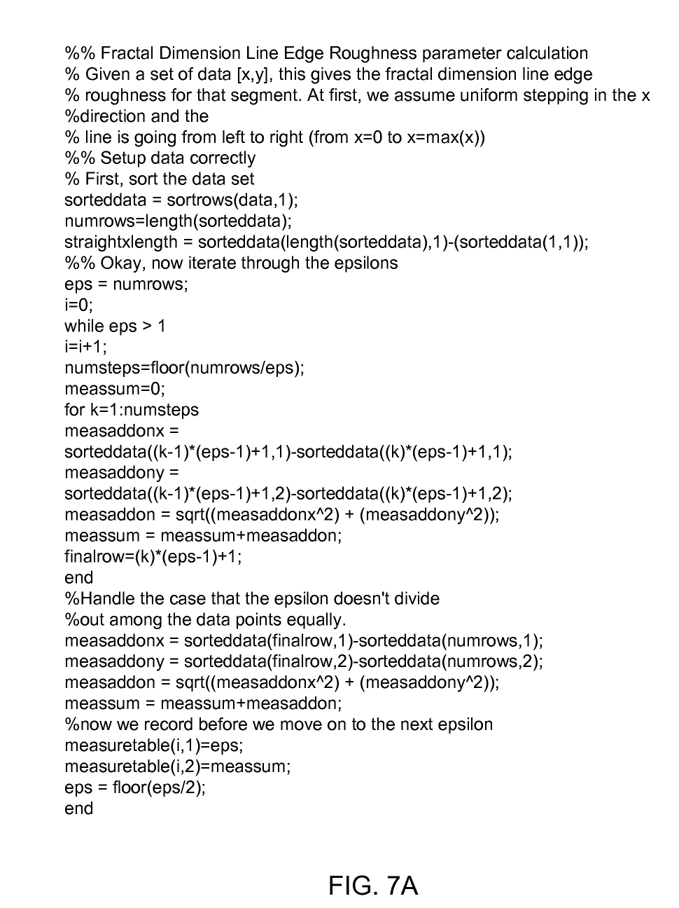

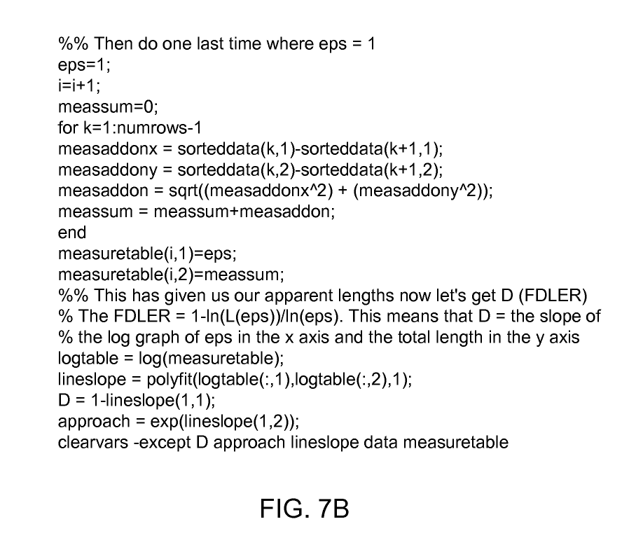

FIG. 7A and FIG. 7B show exemplary programming code for an embodiment of the present invention. FIG. 7A shows programming code (instructions) in MATLAB, which is a simulation tool produced by The MathWorks, Inc, of Natick, Mass. FIG. 7B is a continuation of the listing of instructions from FIG. 7A. The programming instructions perform the steps of sorting the topographic data points so that the topographic points may be iterated through in a uniform direction (e.g. from left to right). Multiple measurements are computed with varying line segment lengths. Dimensional points are obtained using the log of the lengths and corresponding epsilons. A line is either drawn between two of the dimensional points, or best fit between multiple dimensional points. The slope of the line is computed, and then the FDLER parameter is computed based on the slope of the line.

As can now be appreciated, embodiments of the present invention provide an improved method and system for evaluating line edge roughness. A fractal dimension line edge roughness parameter, which ranges from 1 (ideally smooth) to 2 (extremely rough), is used to assess the roughness of semiconductor features such as lines and trenches. Lines with a fractal dimension line edge roughness parameter exceeding a predetermined value may be registered as rejects or failures, as having too much line edge roughness. Embodiments of the present invention may be in the form of a method, system, and/or a computer program product.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method of determining line edge roughness, comprising:
computing a first length for a plurality of points based on a first line size;
computing a second length for the plurality of points based on a second line size; and
determining a fractal dimension line edge roughness parameter based on a difference between the first length and the second length.

2. The method of claim 1, further comprising:
computing a first segment number based on a number of lines of the first line size used for a measurement; and
computing a second segment number based on a number of lines of the second line size used for a measurement.

3. The method of claim 2, further comprising:
computing a first epsilon value by dividing the first length by the first segment number; and
computing a second epsilon value by dividing the second length by the second segment number.

4. The method of claim 3, further comprising:
computing a first dimensional point based on a log of the first epsilon and a log of the first length; and
computing a second dimensional point based on a log of the second epsilon and a log of the second length.

5. The method of claim 4, further comprising:
computing a slope of a line intersecting the first dimensional point and the second dimensional point.

6. The method of claim 3, further comprising:
computing a plurality of dimensional points;
computing a best fit line for the plurality of dimensional points; and
computing a slope of the best fit line.

7. The method of claim 6, wherein the plurality of dimensional points ranges from 100 dimensional points to 1000 dimensional points.

8. The method of claim 1, further comprising:
registering an integrated circuit failure based on a fractal dimension line edge roughness parameter exceeding a predetermined value.

9. The method of claim 8, wherein the predetermined value ranges from 1.4 to 1.6.

10. A system comprising:
a processor, the processor configured and disposed to access non-transitory memory, the non-transitory memory containing instructions, that when executed by the processor, perform the steps of:
computing a first length for a plurality of points based on a first line size;
computing a second length for the plurality of points based on a second line size; and
determining a fractal dimension line edge roughness parameter based on a difference between the first length and the second length.

11. The system of claim 10, wherein the memory further comprises instructions, that when executed by the processor, perform the steps of:
computing a first segment number based on a number of lines of the first line size used for a measurement; and
computing a second segment number based on a number of lines of the second line size used for a measurement.

12. The system of claim 11, wherein the memory further comprises instructions, that when executed by the processor, perform the steps of:
computing a first epsilon value by dividing the first length by the first segment number; and
computing a second epsilon value by dividing the second length by the second segment number.

13. The system of claim 12, wherein the memory further comprises instructions, that when executed by the processor, perform the steps of:
computing a first dimensional point based on a log of the first epsilon and a log of the first length; and
computing a second dimensional point based on a log of the second epsilon and a log of the second length.

14. The system of claim 13, wherein the memory further comprises instructions, that when executed by the processor, perform the steps of:
computing a slope of a line intersecting the first dimensional point and the second dimensional point.

15. The system of claim 12, wherein the memory further comprises instructions, that when executed by the processor, perform the steps of:
computing a plurality of dimensional points;
computing a best fit line for the plurality of dimensional points; and
computing a slope of the best fit line.

16. The system of claim 10, wherein the memory further comprises instructions, that when executed by the processor, perform the step of:
registering an integrated circuit failure based on a fractal dimension line edge roughness parameter exceeding a predetermined value.

17. A computer program product embodied in a non-transitory computer readable medium for execution by a processor, the computer program product comprising:
code for computing a first length for a plurality of points based on a first line size;
code for computing a second length for the plurality of points based on a second line size; and
code for determining a line edge roughness parameter based on a difference between the first length and the second length.

18. The computer program product of claim 17, further comprising:
code for computing a first segment number based on a number of lines of the first line size used for a measurement; and
code for computing a second segment number based on a number of lines of the second line size used for a measurement.

19. The computer program product of claim 18, further comprising:
code for computing a first epsilon value by dividing the first length by the first segment number; and
code for computing a second epsilon value by dividing the second length by the second segment number.

20. The computer program product of claim 19, further comprising:
code for computing a first dimensional point based on a log of the first epsilon and a log of the first length; and
code for computing a second dimensional point based on a log of the second epsilon and a log of the second length.
